(19) United States
(12) Patent Application Publication
(10) Pub. No.: US 2026/0268480 A1
(43) Pub. Date: Sep. 10, 2026

(54) ARTICLE INSPECTION APPARATUS

(71) Applicant: ANRITSU CORPORATION, Kanagawa (JP)

(72) Inventors: Takeshi YAMAZAKI, Kanagawa (JP); Hiroki WATANABE, Kanagawa (JP); Hirotaka NAKAJIMA, Kanagawa (JP); Koetsu TSUNODA, Kanagawa (JP)

(21) Appl. No.: 19/550,429

(22) Filed: Feb. 26, 2026

(30) Foreign Application Priority Data
Mar. 10, 2025 (JP) 2025-037248

(51) Int. Cl. G06T 7/00

(52) U.S. Cl. CPC G06T 7/001; G06T 2207/20084

(57) ABSTRACT

An article inspection apparatus that inspects a quality state of an article to be transported by performing image processing on an image obtained by imaging the article, includes: an image storage unit configured to store the image as a captured image; a first image processing unit configured to detect a partial image region of a defect candidate in the captured image by comparison between an inference value obtained by applying a trained model to the captured image and a predetermined threshold value; and a second image processing unit configured to execute processing of measuring a feature amount with a predetermined image processing algorithm for pass/fail determination for the partial image region of the defect candidate.

### TECHNICAL FIELD

The present invention relates to an article inspection apparatus, and more particularly, to an article inspection apparatus configured to inspect a quality state of an article using an inspection image obtained by imaging the article and a model that has been trained (hereinafter referred to as a trained model).

### BACKGROUND ART

In recent years, there is known an article inspection apparatus that applies a model that has been trained by machine learning, a so-called artificial intelligence (AI) trained model, to an inspection image including a feature amount corresponding to a quality state of an article to inspect the quality state of the article, and displays and outputs, as the inspection image, an image including inspection result information. As for the quality state of the article, article inspection apparatuses that detect contained foreign matter or that detect a defective portion of a product or a package are commonly used.

As such an article inspection apparatus, for example, in order to improve article inspection accuracy, there is an article inspection apparatus configured to capture a plurality of images having different input channels under predetermined imaging conditions corresponding to the respective input channels, and to acquire image data forming a set of a plurality of images of an article and to store the image data in an image storage unit, while, prior thereto, creating a trained model for inspection determination that has been trained by machine learning using training image data acquired under the same imaging conditions as the image data of the article stored in the image storage unit in advance, and using the trained model, to process image data of the article acquired at the time of actual inspection for each pixel to obtain a degree of quality defect thereof, and to compare the degree of quality defect with a preset threshold value to determine the quality state of the article (see, for example, Patent Document 1).

In addition, there is known an apparatus configured to store a plurality of image processing algorithms, each combining a plurality of image processing filters, in storage means so as to be selectably settable, and to make the plurality of image processing algorithms displayable as a plurality of options, and, in accordance with necessary detection characteristics, to enable a setting operation of an image processing algorithm optimal for the necessary detection characteristics to be easily performed, for example, only by performing a selection operation of an image processing algorithm capable of capturing all foreign matters on average or an image processing algorithm suitable for detecting resin-based foreign matter (see, for example, Patent Document 2).

### Related art Document

### Patent Document

[Patent Document 1] JP-A-2023-114828

[Patent Document 2] JP-A-2012-137387

### DISCLOSURE OF THE INVENTION

### Problem that the Invention is to Solve

In an article inspection apparatus having an inspection function using a trained model by AI as described above, there are cases where foreign matter or defective portions (hereinafter referred to as a defective portion and the like) that have been difficult to detect with conventional rule-based processing can be detected, and expansion of an applicable scope is expected; however, in a case where the defective portion and the like are detected based on an inference result of such a trained model, erroneous determinations such as determining a defective product as a non-defective product or determining a non-defective product as a defective product may increase due to insufficient training or biased training.

Therefore, regarding an estimation result as to whether it is a defective portion and the like to be detected, it is necessary to devise measures such as enhancing reliability with respect to a determination result by using, for example, an evaluation index (hereinafter simply referred to as “confidence”) such as confidence or a confidence score, which is a statistical scale, indicating with how much certainty the AI estimates, and by determining that a defective portion and the like desired to be detected has been detected when the confidence exceeds a preset threshold value.

However, in a conventional inspection function using a trained model by AI, even in a case where an approximate magnitude of confidence is known, information is often insufficient to set a suitable threshold value for defect determination, and in order to suppress erroneous detection such as determining a defective product as a non-defective product, the threshold value has to be set high. Therefore, a request to keep the threshold value low to a certain extent so as to be able to detect the defective portion and the like without omission, and a request to set the threshold value high to a certain extent so as to reduce erroneous detection (including over-detection) such as erring in an OK/NG determination, have become difficult to achieve simultaneously.

Therefore, in a case where a trained model is mounted in order to execute an inspection function without omission, when an attempt is made to increase defect detection accuracy to the same level as an inspection function using rule-based processing, erroneous detection determining an OK product as an NG product, that is, over-detection, occurs, resulting in an unresolved problem that required defect detection accuracy cannot be obtained.

An object of the present invention is to provide an article inspection apparatus that solves such a conventional unresolved problem and that can obtain required defect detection accuracy while ensuring detection performance without omission of a defective portion and the like by utilizing a trained model.

### Means for solving the problem

As an example of an embodiment of the present invention, there is provided an article inspection apparatus that inspects a quality state of an article to be transported by performing image processing on an image obtained by imaging the article, the article inspection apparatus including: an image storage unit configured to store the image as a captured image; a first image processing unit configured to detect a partial image region of a defect candidate in the captured image by comparison between an inference value obtained by applying a trained model to the captured image and a predetermined threshold value; and a second image processing unit configured to execute processing of measuring a feature amount with a predetermined image processing algorithm for pass/fail determination for the partial image region of the defect candidate.

With this configuration, by the first image processing unit, the inference value obtained by applying the trained model to the captured image for each article is compared with the predetermined threshold value, and in accordance with a result of the comparison, the partial image region of the defect candidate is detected in the captured image. Then, for the partial image region of the defect candidate, post-processing for defect determination is executed by the second image processing unit with a predetermined image processing algorithm serving as rule-based processing. Therefore, while it is possible to mount an inspection function capable of detecting a defective portion and the like without omission as the partial image region of the defect candidate using the trained model, defect detection accuracy can be sufficiently increased by executing a feature amount measurement function using rule-based processing for the partial image region of each candidate object.

As an example of an embodiment of the present invention, the second image processing unit may be configured to switch the processing of measuring the feature amount in accordance with a predetermined condition related to the first image processing unit for the partial image region of the defect candidate.

In this manner, since rule-based processing suitable for desired inspection accuracy (reduction in overlooking of defects and reduction of an erroneous detection rate of non-defective products) can be performed for each partial image region of the defect candidate in accordance with a condition such as a setting or a processing result with respect to the first image processing unit so as to adapt to the desired inspection accuracy, improvement of the desired inspection accuracy can be achieved. For example, in a case where confidence of inference of the partial image region of the defect candidate by the first image processing unit is low, the second image processing unit can execute image processing for specifying a defective portion and the like with high accuracy, and in a case where the confidence of the inference is high, the second image processing unit can execute image processing for lowering the erroneous detection rate of non-defective products.

As an example of an embodiment of the present invention, the second image processing unit may be configured to switch the processing of measuring the feature amount in accordance with the number of detections of the partial image region of the defect candidate.

In this case, in a case where the number of detections of the partial image region of the defect candidate with respect to the captured image for each article is large, the second image processing unit executes image processing for lowering the erroneous detection rate of non-defective products, and in a case where the number of detections is small, the second image processing unit executes image processing for raising a defect detection rate, thereby enabling determination suitable for desired inspection accuracy to be performed.

As an example of an embodiment of the present invention, the second image processing unit may be configured to switch the processing of measuring the feature amount in accordance with the predetermined threshold value used in the first image processing unit.

In this case, for example, in a case where the threshold value is high, the second image processing unit executes image processing for lowering the erroneous detection rate of non-defective products, and in a case where the threshold value is low, the second image processing unit executes image processing for raising the defect detection rate, thereby enabling determination suitable for desired inspection accuracy to be performed.

As an example of an embodiment of the present invention, the second image processing unit may be configured to switch the processing of measuring the feature amount in accordance with a size of the partial image region of the defect candidate in the captured image for each article.

In this case, a kernel size of a filter applied in image processing can be switched in accordance with the size of the partial image region of the defect candidate in the captured image for each article, thereby enabling determination with improved inspection accuracy to be performed.

As an example of an embodiment of the present invention, the second image processing unit may be configured to execute the processing of measuring the feature amount with the predetermined image processing algorithm for pass/fail determination only for the partial image region of the defect candidate in the captured image, while setting a portion other than the partial image region of the defect candidate in the captured image as a mask region.

In this case, the second image processing unit can collectively process the entire captured image, not for each partial image region, with an existing image processing algorithm capable of mask region setting, thereby enabling determination to be performed.

As an example of an embodiment of the present invention, a configuration may be employed in which the partial image region of the defect candidate is a partial image region corresponding to contained foreign matter in the article.

In this case, an article inspection apparatus capable of increasing foreign matter detection accuracy regarding detection of contained foreign matter in the article by utilizing the trained model is provided.

### Advantage of the Invention

According to the present invention, an article inspection apparatus capable of obtaining required defect detection accuracy while ensuring detection performance without omission of a defective portion and the like by utilizing a trained model can be provided.

### BRIEF DESCRIPTION OF THE DRAWINGS

FIG. 1 is a schematic configuration diagram of an article inspection apparatus according to one embodiment of the present invention.

FIGS. 2A and 2B are explanatory diagrams of a first example showing a procedure for detecting a defective portion and the like by first and second image processing with respect to a captured image for each inspection target article in the article inspection apparatus according to one embodiment of the present invention.

FIGS. 3A and 3B are explanatory diagrams of a second example showing the procedure for detecting the defective portion and the like by the first and second image processing with respect to the captured image for each inspection target article in the article inspection apparatus according to one embodiment of the present invention.

FIGS. 4A and 4B are explanatory diagrams of a third example showing the procedure for detecting the defective portion and the like by the first and second image processing with respect to the captured image for each inspection target article in the article inspection apparatus according to one embodiment of the present invention.

FIG. 5 is a flowchart showing a schematic processing procedure of a detection processing program for the defective portion and the like including the first and second image processing with respect to the captured image for each inspection target article in the article inspection apparatus according to one embodiment of the present invention.

### BEST MODE FOR CARRYING OUT THE INVENTION

Modes for carrying out the present invention will be described below with reference to the drawings.

### One Embodiment

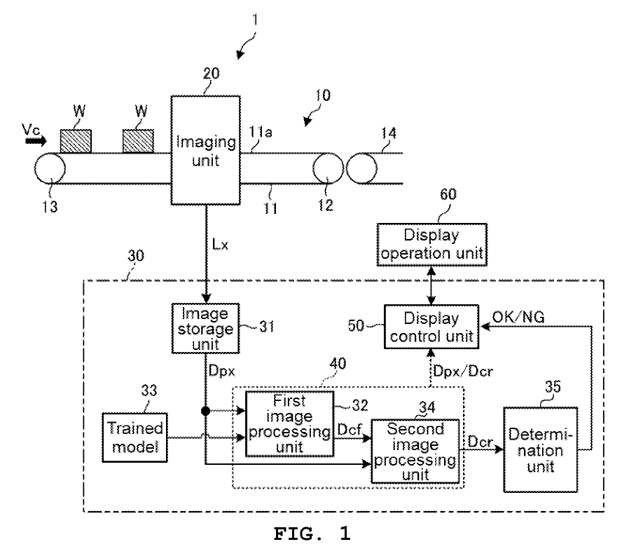

FIGS. 1 to 5 show an article inspection apparatus according to one embodiment of the present invention.

First, a configuration will be described.

As shown in FIG. 1, an article inspection apparatus 1 of the present embodiment includes a transport unit 10 that transports an article W which is an inspection target, an imaging unit 20 that individually images the article W being transported, a control unit 30 for main control including control of these transport unit 10 and imaging unit 20, and a display operation unit 60 such as a touch panel.

Then, this article inspection apparatus 1 is configured to detect an inspection image Dpx having image data (for example, a brightness value) for each pixel corresponding to a transmitted X-ray amount distribution while irradiating the article W conveyor-transported by the transport unit 10 with, for example, X-rays by the imaging unit 20, and to inspect a quality state of the article W based on the inspection image Dpx.

Note that the quality state referred to herein is quality required for the article W as a product, for example, presence or absence of contained foreign matter, presence or absence of a missing item, pass/fail of a shape, a size, a storage state, and the like of contents, and the like, and a defective portion of the quality state usually has an image feature specific to a defect form thereof.

Specifically, the transport unit 10 is formed by winding a loop-shaped transport belt 11 around a driving-side transport roller 12 and a driven-side transport roller 13, and is a conveyor that transports the articles W sequentially introduced from an upstream side onto a transport path 11a which is an upper run section of the transport belt 11 in a rightward direction in FIG. 1, passes the articles W through an imaging section of the imaging unit 20, and carries out the articles W to a downstream conveyor 14, and is supported by a housing (not shown).

Although details are not shown, the imaging unit 20 includes, for example, an X-ray generator (X-ray source) that generates X-rays of a predetermined energy band which are transmitted through the article W transported by the transport unit 10, and an X-ray detector disposed directly below the transport path 11a of the transport belt 11. This imaging unit 20 is not necessarily limited to an imaging unit that acquires the inspection image Dpx by irradiating the article W with X-rays, and may be, for example, an imaging unit that uses an appearance or transmission camera image using near infrared rays (NIR) as the inspection image, or may be an imaging unit that uses a color image obtained by imaging an appearance of the article with other light such as visible light as the inspection image.

In the case of an X-ray inspection method, the X-ray generator of the imaging unit 20 is configured to use a known X-ray tube to generate X-rays of a wavelength and intensity corresponding to a tube current and a tube voltage thereof, and to irradiate the article W on the transport belt 11 with fan-beam-shaped X-rays through an X-ray window portion of an envelope whose details are not shown, in a main observation direction substantially orthogonal to an article transport direction of the transport unit 10.

Additionally, although details are not shown, the X-ray detector of the imaging unit 20 is configured by an X-ray line sensor camera in which detection elements including, for example, a scintillator which is a phosphor, and a photodiode or a charge-coupled device are arranged in an array shape at a predetermined pitch in a width direction of a transport path of the transport unit 10, so as to output a detection signal Lx equivalent to a transmitted X-ray amount at a predetermined resolution, and is disposed at a predetermined position in a transport direction corresponding to an X-ray irradiation position from the X-ray generator. Note that, although an indirect conversion method in which X-rays are converted into light by the scintillator and then electrical signals are output by a photoelectric conversion element is employed here, it goes without saying that a direct conversion method of outputting electrical signals corresponding to an incident X-ray amount to an X-ray sensor element composed of a compound semiconductor or the like may be used.

That is, the imaging unit 20 is configured to detect X-rays emitted from the X-ray generator and transmitted through the article W for each predetermined transmission region corresponding to the detection elements, convert the detection results into electrical signals corresponding to transmitted X-ray amounts, and output X-ray detection signals for generating an X-ray transmission image having a direction in which the X-rays are transmitted as an observation direction. Here, although it is assumed that the X-rays emitted from the X-ray generator or the X-rays detected by the X-ray detector have a constant radiation quality (energy, wavelength) specified in accordance with quality of the article W, a configuration may be employed in which a so-called dual-energy or multi-energy X-ray image can be generated by a plurality of types of X-rays whose radiation qualities are different from each other.

The control unit 30 has a function of transport control means for controlling a transport speed, a transport interval, and the like of the article W by the transport belt 11 in the transport unit 10, and a function of inspection control means for controlling an X-ray irradiation intensity and an irradiation period in the imaging unit 20, and for controlling an X-ray detection cycle in the X-ray line sensor of the X-ray detector corresponding to the transport speed of the article W, a detection period of each article W, and the like.

This control unit 30 includes an image storage unit 31, a first image processing unit 32, a trained model 33, a second image processing unit 34, and a determination unit 35 as main means for executing the function of the inspection control means, and further includes a display image generation unit 40 that generates a display inspection image (an image Dpx or Dcr to be described below) to be displayed on the display operation unit 60 in cooperation with the first image processing unit 32 and the second image processing unit 34, and a display control unit 50 for display control of the display operation unit 60.

This control unit 30 includes, for example, hardware such as a processor including a CPU, a ROM, a RAM, and an I/O interface (not shown), software such as a program for storing a control program for exhibiting each function of a plurality of functional units to be described below in the ROM, an auxiliary storage device, or other recording media in a readable manner, or downloading the control program from another computer via data communication, a timer circuit, and the like, and is configured such that the CPU executes predetermined arithmetic processing while exchanging data with the RAM, and the like in accordance with the control program stored in the ROM, or the like, and executes control programs of the plurality of functional units. Note that the hardware referred to herein may also include a field programmable gate array (FPGA), a digital signal processor (DSP), or a graphics processing unit (GPU), a video processing unit (VPU), and the like.

The image storage unit 31 is configured to sequentially capture X-ray detection signals Lx from the X-ray detector of the imaging unit 20, and while sequentially storing image data indicating a transmitted X-ray amount distribution of each article W in an image memory, to output the image data as an inspection image Dpx for each article W or for each predetermined number of line scans thereof.

The first image processing unit 32 is configured to capture the inspection image Dpx which is a captured image for each article W from the image storage unit 31, and, based on the acquired inspection image Dpx of the article W or the inspection image Dpx after predetermined pre-processing, to execute first image processing of outputting a defective portion and the like to be detected in the article for each article W together with a rectangular display of an object detection result with confidence by an object detection method using the trained model 33, with presence or absence of a predetermined quality state of the article W being treated as whether the quality state is normal (OK) or not normal (NG).

The object detection referred to herein is processing of detecting foreign matter contained into the article W, a defective portion and the like (hereinafter referred to as a defective portion and the like) as an object to be detected from the inspection image Dpx for each imaged article W, and specifically, for example, in a case where a bone to be removed remains in meat which is the article W, the bone is detected as a target object, or in a case where a sausage which is the article W is broken, the broken portion is detected as a target object.

The trained model 33 is a multilayer neural network for executing an object detection function for the inspection image Dpx taken into the first image processing unit 32, and has performed deep learning to be described below for the above-described object detection. Note that an input during training may be numerical data such as an average value, a variance value, a maximum value of pixels, and a product size, instead of the X-ray image itself. Further, in a case where an image is used for a training input, in addition to a transmission image by X-rays only, a difference image using transmission images of different energy bands, or an image by an imaging method of a different optical system such as visible light or NIR, an image obtained by filtering a captured image or the like can be used.

The trained model 33 may have a network configuration in which learning is performed as to whether an inside of a rectangle on the inspection image Dpx is an object or a background in a learning phase thereof, and in a case of the object, learning is performed so as to reduce an error between a category of the object in the rectangle and a ground truth label, and a two-stage processing function of a stage of acquiring a feature map of the input image Dpx and a stage of generating a plurality of rectangles on the feature map and proposing a rectangular candidate region for which inference of classification in each rectangle and an inference error thereof have been calculated in an inference phase is executed.

Specifically, the trained model 33 is a model that has learned features of an image of a non-defective product using image data of a non-defective product image having no abnormality such as foreign matter or a defective portion as a training image dataset in a learning phase thereof, or further, has learned features of an image of a defective product using image data of a defective product image having abnormality such as foreign matter or a defective portion. That is, the trained model 33 is a model that has performed learning to adjust parameters using weights of weighting, such as weights between layers of a neural network, for example, a weight of weighting in any j-th neuron of a hidden layer (intermediate layer) with respect to any i-th neuron of an input layer, and a weight of weighting in any k-th neuron of an output layer with respect to any j-th neuron of the hidden layer, as the parameters, by receiving a predetermined number (for example, about 1000 sheets) of training image datasets as an input, for learning such as learning whether an inside of a rectangular region having a predetermined pixel size in an input image is an object to be detected or a background, and in a case where it is the object to be detected, reducing an error between the category of the object in the rectangular region and the ground truth label.

The dataset of images used for learning of the trained model 33 is, for example, a dataset in which annotation information (OK label, NG label) is added to a sample image, but may be a dataset for which annotation work has been performed so as to attach a score indicating that a degree of being not normal is large to a non-defective product of a category closest to an abnormal product in terms of shape, disposition, or the like, for example, a non-defective product having a defect of a degree difficult to visually recognize or unevenness close to a normal limit.

More specifically, the trained model 33 uses, as an object detection method, for example, an object detection algorithm capable of detecting an object from the entire image by reading the image once and enclosing a position thereof with a rectangular bounding box, and is configured to recognize (classify) that a candidate object Ct is a defective portion and the like with reliable confidence by performing object detection on the partial image region of the defect candidate to be described below as the candidate object Ct.

Then, the first image processing unit 32 using this trained model 33 is configured to, when image data of the inspection image Dpx of the article W is input from the image storage unit 31, grid-divide the input image Dpx into a predetermined number of segments for which label estimation of classification is possible, output a class probability and an offset value (bias) for each rectangular region, and output image data in which a rectangular region having a class probability equal to or higher than a threshold value in an image region of the article W is enclosed by a bounding box as the candidate object Ct of the defective portion and the like to be detected in the image.

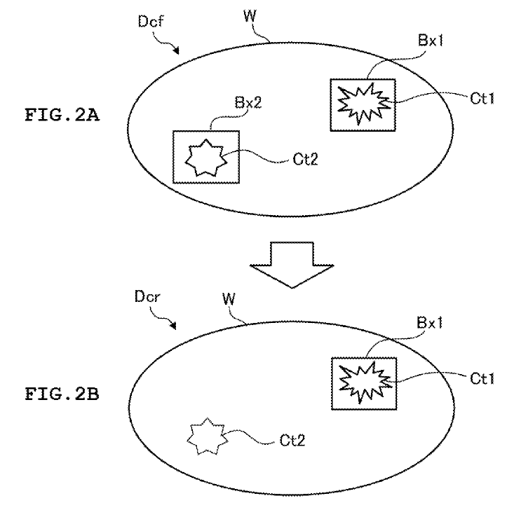

An image Dcf from the first image processing unit 32 is an image in which, for example, as shown by a schematic diagram in FIG. 2A, candidate objects Ct1 and Ct2 are enclosed by bounding boxes Bx1 and Bx2 for each article W being transported.

Meanwhile, the second image processing unit 34 is configured to input detection rectangle data for each article W from the first image processing unit 32 and sequentially input image data of the inspection image Dpx output from the image storage unit 31, and is configured to execute image analysis processing for extracting global features and local features of the input image by predetermined filtering processing with a preset kernel size, and to execute second inspection image processing that enables determination of the presence or absence of a predetermined quality state of the article W based on the result of the image processing using a predetermined image processing algorithm.

Further, the second image processing unit 34 is configured to perform mask processing and composite processing of a plurality of images, and is configured to execute processing of measuring a feature amount to enable pass/fail determination with a predetermined image processing algorithm, only for a partial image region corresponding to each candidate object Ct in the inspection image Dpx for each article W, while setting a portion other than the candidate object Ct in the inspection image Dpx for each article W as a mask region.

Furthermore, the second image processing unit 34 is configured to binarize the input image with a threshold value of a predetermined pixel value (for example, a brightness value), execute labeling processing, and then detect a contour line of the candidate object Ct by executing tracking processing of a plurality of contour lines for a cluster of white pixels, and measure a perimeter which is the contour line length.

The predetermined filtering processing referred to herein is filtering processing of detecting or emphasizing image features (for example, edges or blobs) that show a tendency to deviate from a normal quality state, that is, a degree different from normal. Additionally, the rule-based processing referred to herein refers to processing of calculating a perimeter, an area, a volume, or the like of a portion satisfying a specific condition, in addition to various filters such as labeling.

Therefore, by this rule-based processing, the inference result of the defective portion and the like to be detected in the first image processing can be precisely examined, and a correct determination rate is increased (detection rate improvement). In addition, it is possible to identify correct/incorrect determination by this rule-based processing for a location where a non-defective product may be erroneously detected as a defective product even in a case where a threshold value used for the first image processing is set to be high, thereby enabling erroneous detection to be reduced (erroneous detection rate reduction).

Therefore, the second image processing unit 34 is configured to perform rule-based processing for the rectangular regions enclosed by the bounding boxes Bx1 and Bx2 in the image Dcf from the first image processing unit 32 to improve the detection rate or reduce the erroneous detection rate, respectively, and output an output image Dcr that enables final determination of the quality state, for example, as shown by a schematic diagram in FIG. 2B, in accordance with the result of the rule-based processing.

A first example shown by the schematic diagrams in FIGS. 2A and 2B exemplifies a case where a threshold value for AI detection in the first image processing unit 32 is set to 0.75, candidate objects Ct including erroneous detections are detected in the first image processing, and the result is precisely examined by post-processing of complexity calculation in the second image processing unit 34.

Specifically, the procedure for detecting the defective portion and the like in this case will be described. In the image Dcf from the first image processing unit 32 (see FIG. 2A), the candidate object Ct1 enclosed by the bounding box Bx1 is a first AI detection location that is label-estimated as a defective portion with a confidence of 0.8, and the candidate object Ct2 enclosed by the bounding box Bx2 is a second AI detection location that is label-estimated as a defective portion with a confidence of 0.85. However, the candidate object Ct2 is, in actuality, not a defective portion but an erroneous detection.

Meanwhile, the output image Dcr from the second image processing unit 34 (see FIG. 2B) is an image in which the following processing has been performed by the rule-based processing in the second image processing unit 34: for each of the candidate objects Ct1 and Ct2, the complexity (complexity = P²/A, where the area is denoted by A and the perimeter is denoted by P) of the shape is calculated after labeling the object in the rectangular region enclosed by each of the bounding boxes Bx1 and Bx2; and by executing additional image processing corresponding to the calculation result, the first AI detection location whose complexity is equal to or higher than a predetermined value (for example, a broken portion of a sausage or a fractured surface portion of a baked confectionery) is left as the candidate object Ct1 with the bounding box Bx1, and the candidate object Ct2 for the second AI detection location whose complexity is less than the predetermined value is changed to an OK label estimation region, and the bounding box Bx2 is deleted.

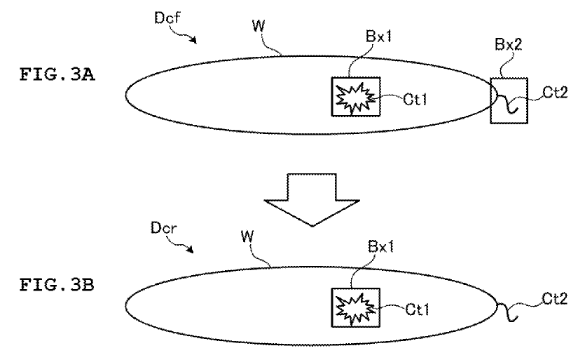

A second example shown in FIGS. 3A and 3B exemplifies a case where a threshold value used in the first image processing unit 32 is set to 0.85, detection is performed while reducing erroneous detection as much as possible in AI detection, and the result is precisely examined by post-processing of area calculation in the second image processing unit 34.

The procedure for detecting the defective portion and the like in this case will be described. In the image Dcf (see FIG. 3A) for each article W (for example, wiener sausage) from the first image processing unit 32, the candidate object Ct1 enclosed by the bounding box Bx1 is a first AI detection location that is label-estimated as a defective portion with a confidence of 0.9, and the candidate object Ct2 enclosed by the bounding box Bx2 is a second AI detection location that is label-estimated as a defective portion with a confidence of 0.88. However, the candidate object Ct2 is, in actuality, a whisker portion obtained by tightening a casing, is not a defective portion, and is an erroneous detection.

Meanwhile, the output image Dcr from the second image processing unit 34 (see FIG. 3B) is an image in which the following processing has been performed by the rule-based processing in the second image processing unit 34: for each of the candidate objects Ct1 and Ct2, the area of the shape is calculated after labeling the object in the rectangular region enclosed by each of the bounding boxes Bx1 and Bx2; and by executing additional image processing corresponding to the calculation result, the first AI detection location whose area is equal to or greater than a predetermined value is left as the candidate object Ct1 with the bounding box Bx1, and the candidate object Ct2 for the second AI detection location whose area is less than the predetermined value is changed to an OK label estimation region as an erroneous detection of the whisker portion, and the bounding box Bx2 is deleted.

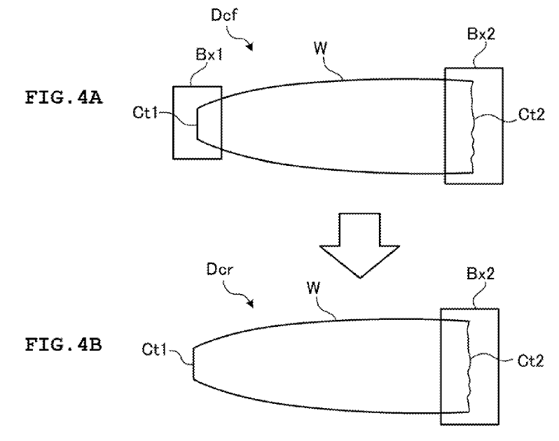

Further, a third example shown by schematic diagrams in FIGS. 4A and 4B exemplifies a case where the threshold value used in the first image processing unit 32 is set to 0.8 for shape inspection that detects a shape-defective portion of the article W, for example, a sausage cut at both ends, by AI detection.

The procedure for detecting the defective portion and the like in this case will be described. In the image Dcf (see FIG. 4A) for each article W from the first image processing unit 32, the candidate object Ct1 enclosed by the bounding box Bx1 is a first AI detection location that is label-estimated as a defective portion with a confidence of 0.87, and the candidate object Ct2 enclosed by the bounding box Bx2 is a second AI detection location that is label-estimated as a defective portion with a confidence of 0.88. However, the candidate object Ct1 is, in actuality, an end face portion cut at both ends, is not a defective portion, and is an erroneous detection.

Meanwhile, the output image Dcr from the second image processing unit 34 (see FIG. 4B) is an image in which the following processing has been performed by the rule-based processing in the second image processing unit 34: for each of the candidate objects Ct1 and Ct2, the edge length of the end face of the shape is calculated after labeling the object in the rectangular region enclosed by each of the bounding boxes Bx1 and Bx2; and by executing additional image processing corresponding to the calculation result, the first AI detection location whose edge length is less than a predetermined value is changed to an OK label estimation region as an erroneous detection and the bounding box Bx1 is deleted, and the candidate object Ct2 for the second AI detection location whose edge length is equal to or greater than the predetermined value is left as a broken defective portion with the bounding box Bx2. In the following description, any candidate object in any image Dcf or output image Dcr is referred to as the candidate object Ct, and any bounding box in any image Dcf or output image Dcr is referred to as the bounding box Bx.

The determination unit 35 is configured to comprehensively determine the presence or absence of a predetermined quality state in the article W based on the result of the serial image processing in the first image processing unit 32 and the second image processing unit 34, determine whether the article W is a non-defective product or a defective product, and output the OK or NG determination result to the display control unit 50.

The display image generation unit 40 is further configured to output either the inspection image Dpx for each article W from the image storage unit 31 taken into the first image processing unit 32 or the output image Dcr from the second image processing unit 34 to the display control unit 50 as an X-ray captured image and an X-ray image corresponding to the inspection result of the article W, each time the article W passes through the imaging region of the imaging unit 20.

The display control unit 50 is configured to execute control to display the inspection image Dpx or the output image Dcr from the second image processing unit 34, which is output as a display image from the display image generation unit 40, together with the OK or NG determination result from the determination unit 35, on the display operation unit 60 in a predetermined inspection result display format.

An inspection result image displayed on the display operation unit 60 may be an image obtained by adjusting, for each pixel, density (pixel density) in accordance with an output value of confidence, or further, in accordance with a ratio of a range of values that confidence and a pixel density designation value can take, and a projection diagram obtained by projecting data on vertical and horizontal axes can also be displayed together. Additionally, the inspection image Dpx may be a color image, and in that case, the gradation of the two-dimensional gradation image may be a pixel value that causes a gradation change only for a specific color component (any of R, G, or B).

Next, an operation will be described.

In the present embodiment configured as described above, in advance, in the learning phase of the trained model 33, the features of a non-defective product image or further a defective product image are learned using a training image dataset, and learning is performed to adjust parameters with weights between layers of the neural network constituting the trained model 33 as parameters. The processing of this learning phase may be executed between the article inspection apparatus 1 and a learning server or the like within the company connected thereto.

Then, when the trained model 33, which has completed learning to adjust the above-described parameters and the like, is mounted in the article inspection apparatus 1, the trained model 33 shifts to the inference phase to be used in the first image processing unit 32.

Next, the inspection by the article inspection apparatus 1 is executed for the article W of the inspection target item.

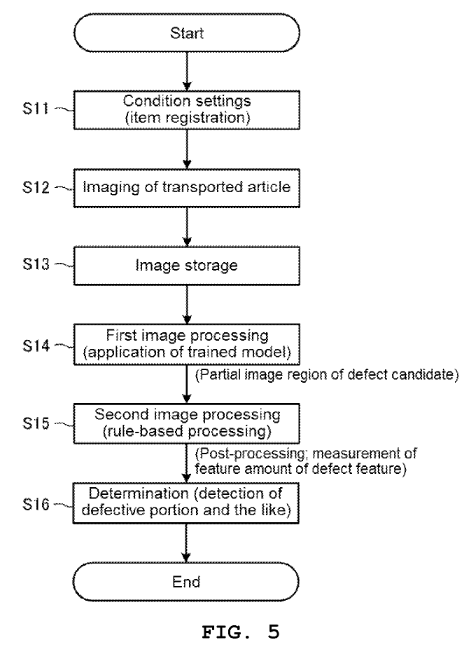

FIG. 5 shows the procedure of the schematic processing during inspection by such an article inspection apparatus 1.

First, various inspection conditions are preset at the time of item registration or other predetermined timings (S11), and defective samples, simulated defective products, or the like, are introduced onto the transport belt 11 of the transport unit 10 and imaged by the imaging unit 20 (S12). At this time, image data showing the transmitted X-ray amount distribution is stored in the image storage unit 31 that sequentially captures the X-ray detection signal Lx from the imaging unit 20 (S13), and the image data of the inspection image Dpx is output from the image storage unit 31 to each of the first image processing unit 32 and the second image processing unit 34.

Next, based on the inspection image Dpx for each article W from the image storage unit 31 or the inspection image Dpx after predetermined pre-processing, the first image processing unit 32 uses an object detection method using the trained model 33 to output, as the object detection result (detection rectangle data) with confidence, the candidate object Ct to be detected in the article W and the image Dcf (S14).

Next, the detection rectangle data from the first image processing unit 32 is taken into the second image processing unit 34, and rule-based post-processing for extracting features of the input image by predetermined filtering processing with a preset kernel size is executed based on the image data of the inspection image Dpx already taken in from the image storage unit 31 for each candidate object Ct shown in the image Dcf. Based on the processing result, a defect feature amount measurement processing by rule-based processing (for example, calculation of the above-described complexity, area, or edge length) is performed for each candidate object Ct (S15). When generating the output image Dcr in the second image processing unit 34, the candidate object Ct for which the bounding box Bx remains can be composited with the image data of the inspection image Dpx in accordance with the positions, thereby enabling the output image Dcr to be generated.

Then, based on the output image Dcr from the second image processing unit 34 that enables final determination of the quality state, that is, based on the result of the serial image processing in the first image processing unit 32 and the second image processing unit 34, the determination unit 35 comprehensively determines the presence or absence of a predetermined quality state in the article W, determines whether the article W is a non-defective product or a defective product, and outputs the OK or NG determination result (S16). Subsequently, the display control unit 50 executes control to display the inspection image Dpx or the output image Dcr from the second image processing unit 34, which is output as a display image from the display image generation unit 40, together with the OK or NG determination result from the determination unit 35, on the display operation unit 60 in a predetermined inspection result display format.

As described above, in the present embodiment, the first image processing unit 32 compares the confidence (inference value) obtained by applying the trained model 33 to the inspection image Dpx, which is the captured image for each article W, with a predetermined threshold value. In accordance with the comparison result, the partial image region of the defect candidate is detected in the captured image Dpx, and detection rectangle data with a bounding box Bx and confidence display, along with the image Dcf, are output. Then, post-processing for defect determination is executed by the second image processing unit 34 using a predetermined image processing algorithm, which serves as rule-based processing, for the partial image region Ct of the defect candidate.

Therefore, the article inspection apparatus 1 can execute an inspection function in the first image processing unit 32 that can detect the defective portion and the like as the partial image region Ct without omission using the trained model 33, and by executing the feature amount measurement function using rule-based processing for the partial image region of each candidate object Ct, the defect detection accuracy can be sufficiently increased.

In addition, in the present embodiment, the second image processing unit 34 can switch the processing during determination processing for the partial image region of the candidate object Ct (defect candidate) in accordance with a predetermined condition related to the first image processing unit 32. Therefore, rule-based processing suitable for the desired inspection accuracy can be performed for each partial image region of the defect candidate in accordance with the predetermined condition, such as a setting or a processing result for the first image processing unit 32, so as to adapt to the desired inspection accuracy, thereby enabling improvement of the desired inspection accuracy to be achieved.

Further, in the present embodiment, the second image processing unit 34 can be configured to switch processing during determination processing in accordance with the number of detections of the candidate objects Ct (the partial image regions of the defect candidates). Therefore, in a case where the number of detections of the candidate objects Ct for the inspection image Dpx for each article W is large, the second image processing unit 34 executes image processing for lowering the erroneous detection rate of non-defective products, while in a case where the number of detections is small, the second image processing unit 34 executes image processing for raising the defect detection rate, thereby enabling determination suitable for desired inspection accuracy to be performed.

Furthermore, in the present embodiment, the second image processing unit 34 can switch processing during determination processing in accordance with a predetermined threshold value used in the first image processing unit 32. Therefore, in a case where the threshold value is high, the second image processing unit 34 executes image processing for lowering the erroneous detection rate of non-defective products, and in a case where the threshold value is low, the second image processing unit 34 executes image processing for raising the defect detection rate, thereby enabling determination suitable for the desired inspection accuracy to be performed.

In addition, in the present embodiment, the second image processing unit 34 can be configured to switch processing during determination processing in accordance with the size (region size) of the candidate object Ct in the inspection image Dpx for each article W. Therefore, a kernel size of a filter applied in image processing can be switched in accordance with the candidate object Ct in the inspection image Dpx for each article W, thereby enabling determination with improved inspection accuracy to be performed.

Further, in the present embodiment, the second image processing unit 34 can be configured to execute processing of measuring the feature amount to enable pass/fail determination with a predetermined image processing algorithm only for the candidate object Ct (the partial image region of the defect candidate) in the inspection image Dpx for each article W, while setting a portion other than the candidate object Ct in the inspection image Dpx for each article W as a mask region. Therefore, the entire captured image can be collectively processed, not for each candidate object Ct, with an existing image processing algorithm capable of mask region setting for the inspection image Dpx for each article W, thereby enabling determination to be performed.

Furthermore, in the present embodiment, a configuration can be employed in which the candidate object Ct (the partial image region of the defect candidate) is a partial image region corresponding to contained foreign matter in the article W. Therefore, an article inspection apparatus 1 capable of increasing foreign matter detection accuracy regarding detection of contained foreign matter in the article by utilizing the trained model 33 is provided.

In this manner, according to the present embodiment, an article inspection apparatus 1 capable of obtaining required defect detection accuracy while ensuring detection performance without omission of a defective portion and the like by utilizing the trained model 33 can be provided.

Note that, in the above-described embodiment, in the learning phase of the trained model 33, image data of non-defective product images having no abnormality such as foreign matter or a defective portion, or further, image data of defective product images having abnormality such as foreign matter or a defective portion can be used as the training image dataset. However, it is also conceivable to use a trained model that has learned only image data of defective product images having abnormality such as foreign matter or a defective portion.

Additionally, regarding the first image processing unit 32, as the object detection method, for example, an object detection algorithm capable of detecting an object from the entire image by reading the image once and enclosing the position with a rectangular bounding box has been described. However, it is a matter of course that a trained model using other algorithms such as classification or anomaly detection can be employed.

As described above, the present invention can provide an article inspection apparatus capable of obtaining required defect detection accuracy while ensuring detection performance without omission of the defective portion and the like by utilizing a trained model, and is useful for article inspection apparatuses in general that inspect a quality state of an article using an inspection image obtained by imaging the article and a trained model.

### DESCRIPTION OF REFERENCE NUMERALS AND SIGNS

1 Article inspection apparatus

10 Transport unit

11 Transport belt

11a Transport path (Upper run section of transport belt)

12, 13 Transport roller

14 Downstream conveyor

20 Imaging unit

30 Control unit

31 Image storage unit

32 First image processing unit

33 Trained model

34 Second image processing unit

35 Determination unit

40 Display image generation unit

50 Display control unit

60 Display operation unit

Bx1, Bx2 Bounding box

Ct1, Ct2 Candidate object (Partial image region of defect candidate)

Dcf Image

Dcr Output image

Dpx Inspection image (Captured image)

W Article

What is claimed is:

1. An article inspection apparatus that inspects a quality state of an article to be transported by performing image processing on an image obtained by imaging the article, the article inspection apparatus comprising:
an image storage unit configured to store the image as a captured image;
a first image processing unit configured to detect a partial image region of a defect candidate in the captured image by comparison between an inference value obtained by applying a trained model to the captured image and a predetermined threshold value; and
a second image processing unit configured to execute processing of measuring a feature amount with a predetermined image processing algorithm for pass/fail determination for the partial image region of the defect candidate.

2. The article inspection apparatus according to claim 1,
wherein the second image processing unit is configured to switch the processing of measuring the feature amount in accordance with a predetermined condition related to the first image processing unit for the partial image region of the defect candidate.

3. The article inspection apparatus according to claim 2,
wherein the second image processing unit switches the processing of measuring the feature amount in accordance with the number of detections of the partial image region of the defect candidate.

4. The article inspection apparatus according to claim 2,
wherein the second image processing unit switches the processing of measuring the feature amount in accordance with the predetermined threshold value used in the first image processing unit.

5. The article inspection apparatus according to claim 2,
wherein the second image processing unit switches the processing of measuring the feature amount in accordance with a size of the partial image region of the defect candidate in the captured image for each article.

6. The article inspection apparatus according to claim 1,
wherein the second image processing unit executes the processing of measuring the feature amount with the predetermined image processing algorithm for pass/fail determination only for the partial image region of the defect candidate in the captured image, while setting a portion other than the partial image region of the defect candidate in the captured image as a mask region.

7. The article inspection apparatus according to claim 1,
wherein the partial image region of the defect candidate is a partial image region corresponding to contained foreign matter in the article.

8. The article inspection apparatus according to claim 2,
wherein the second image processing unit executes the processing of measuring the feature amount with the predetermined image processing algorithm for pass/fail determination only for the partial image region of the defect candidate in the captured image, while setting a portion other than the partial image region of the defect candidate in the captured image as a mask region.

9. The article inspection apparatus according to claim 2,
wherein the partial image region of the defect candidate is a partial image region corresponding to contained foreign matter in the article.

10. The article inspection apparatus according to claim 3,
wherein the second image processing unit executes the processing of measuring the feature amount with the predetermined image processing algorithm for pass/fail determination only for the partial image region of the defect candidate in the captured image, while setting a portion other than the partial image region of the defect candidate in the captured image as a mask region.

11. The article inspection apparatus according to claim 3,
wherein the partial image region of the defect candidate is a partial image region corresponding to contained foreign matter in the article.

12. The article inspection apparatus according to claim 4,
wherein the second image processing unit executes the processing of measuring the feature amount with the predetermined image processing algorithm for pass/fail determination only for the partial image region of the defect candidate in the captured image, while setting a portion other than the partial image region of the defect candidate in the captured image as a mask region.

13. The article inspection apparatus according to claim 4,
wherein the partial image region of the defect candidate is a partial image region corresponding to contained foreign matter in the article.

14. The article inspection apparatus according to claim 5,
wherein the second image processing unit executes the processing of measuring the feature amount with the predetermined image processing algorithm for pass/fail determination only for the partial image region of the defect candidate in the captured image, while setting a portion other than the partial image region of the defect candidate in the captured image as a mask region.

15. The article inspection apparatus according to claim 5,
wherein the partial image region of the defect candidate is a partial image region corresponding to contained foreign matter in the article.
